(19) United States
(12) Patent Application Publication
(10) Pub. No.: US 2007/0044528 A1
(43) Pub. Date: Mar. 1, 2007

(54) Soil Amendment

(75) Inventor: Neil C. Kitchen, Bakersfield, CA (US)

Correspondence Address: VENABLE, CAMPILLO, LOGAN & MEANEY, P.C., 1938 E. OSBORN RD, PHOENIX, AZ, 85016-7234, US

(73) Assignee: AMERICAN SOIL TECHNOLOGIES, INC., Pacoima, CA (US)

(21) Appl. No.: 11/469,273

(22) Filed: Aug. 31, 2006

Related U.S. Application Data
(60) Provisional application No. 60/713,298, filed on Sep. 1, 2005.

(51) Int. Cl. C05C 9/00

(52) U.S. Cl. 71/28

(57) ABSTRACT

The invention is a pumpable, liquid soil amendment derived from “pre-hydrating” large-grained hydrogels with liquid fertilizer. The use of large-grained hydrogels makes mixing and measuring in the field manageable. The resulting pumpable liquid allows for application by conventional liquid fertilizer applicators that are commonly used for banding or side-dressing fertilizer.

### CROSS-REFERENCE TO RELATED APPLICATIONS

The present application claims priority to copending U.S. provisional application entitled “Improved Soil Amendment,” having Ser. No. 60/713,298, filed on Sep. 1, 2005.

### FIELD

The present invention relates generally to soil amendments, and more specifically to soil amendments involving a mixture of fertilizer and hydrogel.

### BACKGROUND

Fertilizers are a common and preferred treatment used in modern agriculture. Hydrogels (i.e., cross-linked polymers) have been used in various capacities to enhance plant growth. See, e.g. U.S. Pat. No. 5,303,663 (Salestrom), U.S. Pat. No. 5,659,998 (Salestrom), U.S. Pat. No. 5,649,495 (Salestrom), and U.S. Pat. No. 5,868,087 (Salestrom). The applicant is aware of nothing, however, that discloses the aspects of current invention.

### SUMMARY

The invention summary that follows is only for purposes of introducing embodiments of the invention. The ultimate scope of the invention is to be limited only by the claims that follow the specification.

The invention is summarized as a pumpable, liquid soil amendment derived from “pre-hydrating” large-grained hydrogels with liquid fertilizer. The use of large-grained hydrogels makes mixing and measuring in the field manageable. The resulting pumpable liquid allows for application by conventional liquid fertilizer applicators that are commonly used for banding or side-dressing fertilizer.

As a result, the improved soil amendment increases the effectiveness of the fertilizer by significantly reducing leaching of the fertilizer from the root zone. This makes the fertilizer available to the plant longer and reduces the negative impact conventional fertilizer applications have on the environment. The improved soil amendment changes the primary leaching mechanism within the soil profile from gravity to osmotic influenced leaching. The liquid fertilizer and gel mixture can be side dressed into the seed row using conventional liquid fertilizer side dress application equipment.

It is an object of the present invention to pre-hydrate cross-linked polymers having particle sizes larger than 200 microns with liquid fertilizer in a way that the resulting mixture can pump and flow smoothly.

It is an object of the present invention to pre-hydrate cross-linked polymers having particle sizes larger than 200 microns with liquid fertilizer in a way that the resulting mixture can pump and flow smoothly through conventional liquid fertilizer application equipment that is commonly used for banding or side-dressing fertilizer.

The description of the invention which follows, together with the accompanying drawings should not be construed as limiting the invention to the example shown and described, because those skilled in the art to which this invention appertains will be able to devise other forms thereof within the ambit of the appended claims.

### DESCRIPTION OF PREFERRED EMBODIMENTS

The descriptions that follow are intended to aid in the understanding but not limit the actual scope of the invention. It is to be understood that the descriptions below are merely illustrative of the presently preferred embodiments of the invention and that no limitations are intended to the detail of construction or design herein shown other than as defined in the appended claims. The descriptions that follow describe the intended and preferred use of each embodiment of the improved soil amendment.

For the purposes of this specification, the term “hydgrogel” means a water-absorbent polymer. For the purposes of this specification, the term “large-grained grained hydrogel” means a hydrogel having dry particle sizes greater than 200 microns. For the purposes of this specification, the term “fine-grained” hydrogel means a hydrogel having a majority of dry particle sizes less than 200 microns.

### Preferred Hydrogels

The preferred hydrogel is a cross-linked polymer, such as a potassium ammonium polyacrylamide/polyacrylate co-polymer. An example of such a cross-linked polymer is sold in the United States under the trademark STOCKOSORB®.

It is preferred to use large-grained hydgrogels because large-grained hydrogels are easier to handle in the field than fine-grained hydrogels. An example of a large-grained hydrogel is sold in the United States under the trademark STOCKOSORB S™. Fine-grained hydrogels are powdery substances that require specialized blending equipment because they blow around easily, are difficult to control, and are difficult to measure. An example of a fine-grained hydrogel is sold in the United States under the trademark STOCKOSORB F™.

In addition to handling difficulties, fine-grained hydrogels tend to float on the surface and form large clumps that are difficult to disassociate. Large-grained hydgrogels, on the other hand, tend to sink below the surface and then go into suspension with a small amount of agitation. Finally, most granular fertilizers are closer in particle size to large-grained hydrogels than they are to fine-grained hydgrogels. As a result, when blended in a dry form, large-grained hydrogels do not separate from the blend during transport nearly as much as fine-grained hydgrogels.

### Preferred Fertilizer

Selection of liquid fertilizer is important. Many fertilizer formulations can destroy the hydrogel. For example, fertilizer formulations having divalent cations present can cause the gel matrix to collapse which results in the virtual destruction of the gel. Divalent cations have also been known to retard re-hydration. Some commercial liquid fertilizers, however, are void of hydrogel re-hydration inhibitors like Ca++. Examples of such liquid fertilizers include those sold commercially in the United States as DUNE UP™ and SUPER PHOS DUNE™, as well as liquid fertilizers manufactured by Agro Cultural Liquid Fertilizers and sold commercially in the United States as PRO GERMINATION 9-24-3™, SURE K™, HIGH NRG N™, MICRO 500™. Testing of such liquid fertilizers revealed that release of the liquid fertilizer from the sand media after irrigation was appreciably delayed when applied with Stockosorb S.

When applied mixed with a larger grained polymer, the release of these liquid fertilizers from the polymer after irrigation is appreciably delayed (after complete hydration with the larger grained polymer). As discussed in more detail below, the hydrogel must be blended with the liquid fertilizer at the desired application rate. The ratio between the gel and fertilizer has physical limits that are primarily a function of the particle size of the granular gel, the chemistry of the fertilizer, and application rate of the fertilizer.

In general, it is estimated that Stockosorb S can be applied (in a pump able solution) at a rate of approximately 2.5% to 3.0% of the weight of liquid fertilizer without the resulting mixture becoming like cottage cheese and unpumpable.

| | App rate | | | |
|---|---|---|---|---|
| | S.G. | Gal/AC | lbs per acre | Est. Max Stock S |
| High NRG N | 10.7 | 30 | 321 | 8.988 |
| Micro 500 | 9.6 | 0.5 | 4.8 | 0.1392 |
| Pro | 11.1 | 3 | 33.3 | 1.0656 |
| Germination | | | | |
| 9-24-3 | | | | |
| Sure K | 9.4 | 5 | 47 | 1.0105 |

Sure K has been found to be an exception to this general rule because it appears to have an upper limit of approximately 2.1% of the weight of the Sure K. Micro 500 is applied at a rate of only one-half gallon per acre. As the table above indicates, this limits the amount of Stock S that can be applied with Micro 500 to approximately 0.14 lbs. per acre.

### Ammonium Sulfate

Each liquid fertilizer formulation will likely have a different mixing ratio of fertilizer to polymer due primarily to the difference in ionic charge among liquid fertilizer formulations. Concentrations beyond a ratio of approximately 2.8% w/w polymer to liquid fertilizer, however, typically result in an unpumpable, “cottage cheese” like mixture. The resulting mixture becomes too thick to flow, which makes the mixture too viscous to pump with conventional fertilizer application equipment.

In order to overcome this problem in applications where a much higher ratio of polymer to fertilizer is required or desired, the gel can be hydrated in an ammonium sulfate or other ammonium (e.g., ammonium nitrate) solution to reduce the viscosity of the mixture. It is preferred to use a salt that is minimally toxic to plants, relatively inexpensive, effective to inhibit gel swelling, and a salt that does not inhibit re-hydration to nearly 100% “field capacity” when the polymer is subsequently exposed to irrigation water. It is preferred to use ammonium sulfate.

By adding an ammonium sulfate solution to the liquid fertilizer before adding water, the ratio of polymer to water can be increased while the result remains a pumpable aqueous solution. For example, when added in the proper amount, ammonium sulfate makes it possible to increase the polymer to fertilizer ratio so that a relatively low volume of liquid fertilizer can pre-hydrate a one to three pound per acre Stockosorb S application. This same technique make possible increased application rates of Stockosorb S when applied in solution with Micro 500, Pro Germination 9-24-3, and Sure K.

### Preferred Method of Preparation

A procedure for use of ammonium sulfate in liquid fertilizer applications that will generally overcome the issue of viscosity, is described below as follows:

First, determine the desired or “target” application rate per acre for the large-grained hydrogel and for the liquid fertilizer. Next, calculate the ratio w/w of gel to liquid fertilizer. If the ratio is 2.8% or less, the mixture will in most cases not require amendment with an ammonium sulfate solution. If the ratio is greater than 2.8%, the following procedure will in most cases produce a mixture that will both flow easily and pump easily.

Calculations:

| | |
|---|---|
| Ammonium sulfate required (lbs/ac): | lbs polymer per acre × 3.333 |
| Water required (gallons/ac): | lbs polymer per acre + lbs |
| | ammonium sulfate − gallons |
| | fertilizer per acre |

### Example

Suppose the target rate for liquid fertilizer that weighs 10.2 pounds per gallon is 3 gallons per acre and the target rate for polymer is 3 pounds per acre. This is a ratio of polymer to fertilizer of approximately 9.8%. This ratio is outside the maximum 2.8% w/w rule of thumb described above. Accordingly, the following mix design can be employed in accordance with the formula (“calculations”) shown above:
Ammonium sulfate required: 3×3.333=9.99 pounds per acre
Water required: (3+9.999)−3=9.99 gallons per acre

### Procedure For Mixing (Ten Acre Application)

1. Add 99.9 gallons water (9.99× ten acres) plus 30 gallons (3× ten acres) liquid fertilizer to the fertilizer tank or “batch tank”.

2. Add 99.9 pounds ammonium sulfate (9.99× ten acres) while circulating the mixture with a circulating pump and/or by agitating with a mechanical agitator until the ammonium sulfate is in solution.

3. While circulating the ammonium sulfate, water, and liquid fertilizer solution, slowly add 30 pounds (3× ten acres) of Stockosorb S granules to the solution. Continue to circulate for a minimum of 15 minutes.

Note Regarding Effective Mixing

When mixing with a circulation pump, it is important to add the ammonium sulfate and polymer directly into the discharge stream of the mixture at the top of the tank. When mixing with a mechanical agitator, place the ammonium sulfate and polymer as close as possible to the agitator. With respect to addition of the polymer, take care to add the polymer relatively slowly to avoid “clumping” (binding together of individual polymer granules).

### LIMITATIONS

It should be noted that the ratio of ammonium sulfate to water described in the example above is approximately 119.8 grams per liter. This is equivalent to slightly over 20% AMS saturation at 25 degrees C. The 100% saturation point for ammonium sulfate at 25 degrees C. is 767 grams per liter (4.1 M). However, with reference to the mix design described above wherein the ratio of gel to AMS is 0.3, this same relationship does not extend beyond approximately 22% AMS saturation.

For example, if a user were to increase the ammonium sulfate concentration to 30% saturation at 25 degrees C. (176 grams/liter of solution) and add Stockosorb S at a ratio of 0.3 w/w of the AMS (the same ratio applied at the slightly over 20% AMS saturation rate described above) the resulting mixture could not be pumped by conventional fertilizer application equipment. Indeed, it would require approximately 60% AMS saturation (390 grams per liter) to yield a pumpable mix that contained Stockosorb S at a ratio of 0.3 w/w Stockosorb S to 30% saturation of AMS at 25 degrees C. In other words, if a user increases the Stockosorb S by approximately 54% (.3 w/w gel to AMS at 20% AMS saturation to 0.3 w/w gel to AMS at 30% AMS saturation) the user will also need to increase the AMS concentration by approximately 242% (from 114 grams AMS per liter to 390 grams AMS per liter) in order to maintain a mixture that is pumpable.

The precise upper limit at which Stockosorb S can be added to a solution of AMS, water and fertilizer, and yield a pumpable mixture is a function of many variables that include, temperature, fertilizer formulation, AMS saturation percentage, and fertilizer application equipment. Above approximately 25% AMS saturation, the relative increase in polymer concentration that can be attained per unit of AMS is marginal and this relationship establishes practical limits with regard to AMS saturation and polymer concentration.

### Observations

A formulation consisting of approximately one pound Stockosorb S per acre blended with three gallons 9-24-3 produces an aqueous pump able mixture for side-dress application in the field. This formulation is equivalent to applying one pound per acre Stockosorb S with 3 gallons Dune Up. Dune Up is generally applied at an application rate of 10 to 20 gallons per acre side-dressed. Accordingly, at the ten-gallon per acre application rate, a user can apply approximately 3 pounds of Stockosorb S with the Dune Up and maintain a pump able aqueous mixture.

The application mix should not be pre-mixed and stored without agitation more than four or five hours in advance of application, or the hydrated polymer will separate from the liquid fertilizer. When lightly agitated, the polymer remains in suspension.

The polymer must have sufficient time to completely equilibrate with the concentrated fertilizer solution before it is hydrated with water or it will preferentially hydrate with a diluted outside bathing solution (diluted fertilizer). This will result in increased leaching of the fertilizer. The application mix should not be pre-mixed and stored without agitation more than four or five hours in advance of application, or the hydrated polymer will separate from the liquid fertilizer. When lightly agitated, the polymer remains in suspension.

The polymer significantly impacts fertilizer release ratios. Applicant has observed the degree of release delay to be surprising. In addition, Applicant has observed that subsequent irrigation virtually restores the hydration potential of the Stockosorb S.

### Linear Polymer

An optional embodiment of the improved soil amendment adds a polyacrylamide (PAM), which is commonly referred to as “linear polymer”, to the mixture. The preferred linear polymer is sold commercially in the United States under the trademark Stockopam®, which is made from acrylamide and sodium acrylate copolymer. The percent of sodium acrylate copolymerized in PAM is expressed as the charge density, which generally ranges from 2 to 40% for commercially available PAMs (Barvenik, 1994). The preferred molecular weight of PAM for the subject application is approximately 20 Mg mol⁻¹. Linear polymers dissolve in water and because their gyration radius is generally much smaller than most soil mircopores and because PAM's sorption kinetics are relatively slow, PAM can move readily in an aqueous solution such as irrigation water. PAM has been used for decades to reduce soil erosion and runoff in furrow irrigation and to improve soil and water quality and water use efficiency. As a soil conditioner, PAM is used in furrow and pivot irrigation systems to stabilize soil aggregates and to flocculate suspended particles. In irrigated agricultural applications, PAM has been found to be cost effective only when applied to the irrigation water rather than mechanically incorporated directly into the soil.

The surface of soil particles suspended in water become positively charged by cations that bind to the negatively charged soil particles. This binding action provides a bridge for the dissolved linear polymer's negatively charged structure to bind to the soil particles. The mixture of soil and polymer bind together (agglomeration) resulting in particles too large to remain suspended and consequently settle-out in the irrigation furrow. This activity greatly improves water infiltration into the seed row and limits soil erosion.

When clay soil aggegates are impacted by mechanical and other destructive forces, the soil aggregates often fracture causing colloidal particles to disburse. This results in increased soil bulk density (decreased soil pore volume). Any decrease in soil pore volume reduces the volume of water, applied nutrients, and air available within the soil profile. When liquid fertilizer is banded, side dressed, or otherwise mechanically incorporated into the seed row, destruction of clay soil aggregates, while undesirable, is unavoidable. Application of PAM applied with the liquid fertilizer and hydrogel mix described above, will agglomerate clay soil particles disbursed by the destructive forces that accompany application of the liquid fertilizer.

PAM increases the apparent viscosity of water and causes the water to infiltrate more slowly into the soil profile. In addition, because control of the viscosity of the mixture of liquid fertilizer and hydrogel is critical to produce a mixture that will flow and pump using conventional liquid fertilizer equipment, the preferred application rate for PAM when applied with liquid fertilizer and gel is approximately 300 parts per million. It should be noted that the upper concentration limit for a solution of PAM and water when applied to irrigation water is approximately 2,500 parts per million (when granular PAM is mixed with water as a make-up solution) and the target concentration of PAM in irrigation water when used for erosion control is approximately 10 parts per million.

### Preferred Mix

Because of the many variables (e.g., fertilizer chemistry, application rate for the fertilizer and for the polymer, application equipment limitations, ambient temperature, water chemistry, etc.), there is no universally “preferred” mix. It is preferred, however, to use as little AMS as possible. It is also preferred to avoid adding only water (water not amended with AMS) to the fertilizer/hydrogel mix because adding only water causes virtually immediate separation of the hydrogel from suspension (the gel will float to the top of the tank).

### Bench Test 1

Test trays, each containing 1,000 grams of 30-mesh sand, were prepared. Identically placed holes were made in the bottom of each tray for drainage. Each of the trays was placed in an individual container tray where leachate from irrigation applications was collected and tested for electrical conductivity. The upper range of conductivity that could be measured with the Ec device used in the test was 19.9 mS/cm (approximately 12,736 parts per million).

Three control trays were prepared. 100 grams of Dune Up was added to each control tray. These trays were irrigated with 300 milliliters of tap water. Six additional trays were prepared and 100 grams of Dune Up was added to each of these “variable” trays. Stockosorb F was added to one of the variable trays at ratio of 2.8% by weight of the liquid fertilizer (2.8 grams in 100 grams liquid fertilizer) and 2.1 grams of AMS was also added. This tray was irrigated with 300 ml of a 300 PPM Stockopam solution and labeled SS F+PAM 300 PPM+AMS 2.1. Stockosorb S was added to a second variable test tray at ratio of 2.8% by weight of the liquid fertilizer (2.8 grams in 100 grams liquid fertilizer) and 2.1 grams of AMS was added to this tray. The tray was then irrigated with 300 ml of a 300 PPM Stockopam solution and labeled SS S+PAM 300 PPM+AMS 2.1. 2.5 grams of Stockosorb S was added to a third tray, which was then irrigated with 300 ml of an 8,600 PPM solution of Stockopam. This tray was labeled SS S 2.5+8600 PPM PAM. The three remaining variable trays were each irrigated with 300 milliliters of an 8,600 PPM solution of Micro Pam, 8,600 PPM Stockopam, and 1,000 PPM Stockopam, respectively, and labeled in accordance with the respective Pam application.

The initial 300-milliliter irrigation was sufficient to saturate the sand, but yielded a very small amount of leachate at the bottom of the collection trays. Applying 200 milliliters of tap water to each tray at approximately 24-hour intervals completed four subsequent irrigations. The fifth and last 200 ml tape water irrigation was applied approximately 48 hours after the fourth 200 ml irrigation. The Ec of the leachate was measured after each of the five 200 ml irrigation events and the mass of water held in each tray (minus leachate water) was recorded.

The tables below present values recorded for Ec and hydration:

| | 300 ml #1 | 200 #2 | 200 #3 | 200 #4 | 200 #5 | 200 #6 |
|---|---|---|---|---|---|---|
| Ec Data | | | | | | |
| Control #1 (100 g Dune up) | >19.9 | >19.9 | 13.45 | 4.8 | 1.92 | 1.26 |
| Control #2 (100 g Dune up) | >19.9 | >19.9 | 12.62 | 4.78 | 1.97 | 1.35 |
| Control #3 (100 g Dune up) | >19.9 | >19.9 | 14.95 | 4.76 | 1.95 | 1.25 |
| PAM 8600 PPM | >19.9 | >19.9 | 14.13 | 3.78 | 1.87 | 1.54 |
| PAM 1000 PPM | >19.9 | >19.9 | 12.7 | 2.75 | 1.29 | 0.94 |
| Micro Pam 8600 PPM | >19.9 | >19.9 | 12.7 | 4.93 | 2.2 | 1.95 |
| SS S 2.5 + PAM 8600 ppm | >19.9 | >19.9 | >19.9 | >19.9 | 9.72 | 7.36 |
| SS F 2.8 + PAM 300 ppm + AMS 2.1 | >19.9 | >19.9 | >19.9 | >19.9 | 9.82 | 5.5 |
| SS S 2.8 + PAM 300 ppm + AMS 2.1 | >19.9 | >19.9 | >19.9 | >19.9 | 14.63 | 9.81 |
| Net Hydration Data (grams) | | | | | | |
| Control #1 (100 g Dune up) | 272.8 | 256.8 | 227.5 | 243.7 | 249.2 | 149.7 |
| Control #2 (100 g Dune up) | 263.4 | 258.5 | 231.5 | 242.1 | 245.6 | 160.7 |
| Control #3 (100 g Dune up) | 279.9 | 269.1 | 242.7 | 253.7 | 256.9 | 182.1 |
| PAM 8600 PPM | 272.7 | 263.2 | 231.5 | 242.7 | 244.99 | 153.4 |
| PAM 1000 PPM | 262.7 | 251.3 | 221.3 | 230.1 | 238.6 | 201.6 |
| Micro Pam 8600 PPM | 276 | 255.1 | 221.8 | 229.6 | 231.3 | 129 |
| SS S 2.5 + PAM 8600 ppm | 348.3 | 352.4 | 347.8 | 385.7 | 410.1 | 363.3 |
| SS F 2.8 + PAM 300 ppm + AMS 2.1 | 340.6 | 361.6 | 368.1 | 425.4 | 464.9 | 411.2 |
| SS S 2.8 + PAM 300 ppm + AMS 2.1 | 354.7 | 376.9 | 384.3 | 446.1 | 496.4 | 421.9 |

As shown in the Ec table above, all trays except the Stockosorb trays contained measurable Ec values after the second 200 ml irrigation. The Stockosorb trays maintained an Ec value greater than 19.9 until the fifth irrigation event at which the Stocksorb trays averaged nearly six times greater Ec value than the average Ec value of the control trays. This is equivalent to approximately 1,245 PPM nutrient concentration in the control trays compared to 7,290 PPM nutrient concentration in the trays containing Stockosorb.

The Net Hydration Data table indicates a definite trend toward increasing hydration with the Stockosorb 2.8 gram test trays attaining an average of approximately 90 times their weight in water after being pre-hydrated with Dune Up. This is consistent with hydration values recorded during the Agro tests.

After the fifth 200 ml irrigation (labeled “200 #6” in the table above) the “SS S 2.8+PAM 300 ppm+AMS 2.1” tray contained approximately 7.5 times the nutrient concentration than the control trays.

Due to the upper limit limitation of the Ec probe used in the test, we know only that after the first 200 ml irrigation all Ec values were greater than 19.9 mS/cm. However, additional tests could be made to approximate the concentration of fertilizer lost as a result of this first 200 ml irrigation. I suspect the results would be alarming based on the values recorded after the third 200 ml irrigation. The ending Ec values are significant.

It was observed during the irrigation events that all trays that did not contain PAM had relatively high turbidity while the leachate in the trays containing PAM remained clear. It was also observed that the infiltration rate of the PAM treated sand was significantly slower than the infiltration rate of the untreated trays.

### Bench Test 2

Test trays, each containing 1,000 grams of 30-mesh sand, were prepared. Identically placed holes were made in the bottom of each tray for drainage. Each of the trays was placed in an individual container tray where leachate from irrigation applications was collected and tested for electrical conductivity. The upper range of conductivity that could be measured with the Ec device used in the test was 19.9 mS/cm (approximately 12,736 parts per million). The initial application rate for the respective fertilizer and Stockosorb S is shown below:

Initial Tray Preparation

| | | | Net | | |
|---|---|---|---|---|---|
| | | Grams | Grams | | Net Gr. |
| | Grams gross | Hydrated | Fertilizer | Net Grams | Fertilizer |
| FERTILIZER | Wt. (dry) | Mix | & Stock S | Stockosorb S | Added |
| High NRG N | 1076.3 | 1173.1 | 96.8 | 2.8 | 94 |
| Micro 500 | 1075.4 | 1168.6 | 93.2 | 3 | 90.2 |
| Pro Germination 9-24-3 | 1074.7 | 1167.7 | 93 | 3 | 90 |
| Sure K | 1074.0 | 1167.6 | 93.6 | 2.1 | 91.5 |
| Blend of NRG + MICRO + PRO + K | 1073.2 | 1170.7 | 97.5 | 2.8 | 94.7 |
| Ec Test with Pro Germination 9-24-3 | 1073.8 | 1166.8 | 93 | 0 | 93 |

An initial 300-milliliter irrigation was sufficient to saturate the sand, and yield a small amount of leachate at the bottom of the collection trays. Applying 200 milliliters of tap water to each tray at approximately 24-hour intervals completed six subsequent irrigation events. The Ec of the leachate was measured after each of the six 200 ml irrigation events and the mass of water held in each tray (minus leachate water) was recorded.

The tables below present values recorded for Ec and hydration:

| | Grams of | | | | | | |
|---|---|---|---|---|---|---|---|
| | Water | Water added | | | | | |
| Net HYDRATION DATA | Held | 300 ml | 200 ml | 200 ml | 200 ml | 200 ml | 200 ml |
| High NRG N | 361.6 | 371.2 | 362.1 | 394.1 | 449.6 | 505.8 | 540.4 |
| Micro 500 | 360.8 | 368.7 | 415.2 | 466.2 | 516.5 | 570.3 | 587.2 |
| Pro Germination 9-24-3 + Stockosorb | 371.3 | 409.4 | 423.8 | 483 | 537.7 | 593.6 | 631.1 |
| Sure K | 348.8 | 341.1 | 371.5 | 396.7 | 436.3 | 478.3 | 505.5 |
| Blend of NRG + MICRO + PRO + K | 349.5 | 374.3 | 380.1 | 410.8 | 490.6 | 526.4 | 546.2 |
| Pro Germination 9-24-3 Only | 282.6 | 282.6 | 282.6 | 282.6 | 282.6 | 282.6 | 282.6 |

| | 1 300 ml | 2 200 ml | 3 200 ml | 4 200 ml | 5 200 ml | 6 200 ml | 7 200 ml |
|---|---|---|---|---|---|---|---|
| Electrical Conductivity of Rinsate | DI | DI | DI | DI | tap | tap | tap |
| High NRG N | >19.99 | >19.99 | >19.99 | >19.99 | 13.45 | 6.58 | 3.4 |
| Micro 500 | >19.99 | >19.99 | >19.99 | 12.74 | 6.86 | 3.8 | 2.19 |
| Pro Germination 9-24-3 | >19.99 | >19.99 | >19.99 | >19.99 | 15.11 | 8.85 | 5.22 |
| Sure K | >19.99 | >19.99 | >19.99 | 15.89 | 6.98 | 3.17 | 1.74 |
| Blend of NRG + MICRO + PRO + K | >19.99 | >19.99 | >19.99 | >19.99 | 14.68 | 8.28 | 4.59 |
| Ec Test with NRG N ONLY | 361 | 49.38 | 4.03 | 0.44 | 0.17 | 0.03 | 0.01 |
| Ec Test with Pro Ger 9-24-3 ONLY | 225.5 | 65.76 | 6.35 | 0.95 | 0.27 | 0.13 | 0.05 |

The hydration values indicate that each fertilizer tested is compatible with Stockosorb in terms of re-hydration potential. There is a definite trend toward increased hydration following each irrigation event.

It should be noted that the “Blend” sample was formulated in accordance with the respective application rate of each fertilizer by weight as follows:

| | |
|---|---|
| High NRG N | 79% |
| Micro 500 | 1% |
| Pro Germination 9-24-3 | 8% |
| Sure K | 12% |

Ec values were not recorded above 19.99 dS/m for the Sockosorb/fertilizer solutions. Values corresponding to the “Ec Test with NRG N ONLY” (no Stockosorb) and “Ec Test with Pro Ger 9-24-3 ONLY” applicable to the first and second hydration events are estimated values determined by diluting the rinsate. All other values corresponding to these tests and all other data reported below 19.99 dS/m are measured values. As the table above indicates, only the Micro 500 and Sure K samples had measurable Ec values after the fourth irrigation. Only after the fifth irrigation did the High NRG, 9-24-3 and Blend samples have measurable Ec values. This indicates that the polymer treated trays held much higher concentrations of fertilizer than the untreated (no polymer added) trays.

### Benefits

Many areas in the United States are now experiencing ground water contamination from nitrates. A major source of nitrate contamination is known to stem from fertilizer applications. Nitrates not used by the plant often leach into and contaminate the ground water. The improved soil amendment seriously impedes this leaching process. Target users of the improved soil amendment include farmers, nursery operators, homeowners and the turf industry owners and managers.

The improved soil amendment reduces leaching of the fertilizer nutrients and thereby makes the fertilizer available to the root system for a longer duration of time. This is accomplished by significantly changing the primary leaching mechanism within the soil profile from gravity to osmotic influenced leaching. Increased fertilizer retention in the root and/or seed zone equates to better utilization of fertilizer, reduced fertilizer cost, increased yield, and reduced environmental insult.

The improved soil amendment reduces the application rate of nitrogen and other fertilizers by holding the fertilizer in the root zone significantly longer than conventional methods and thereby significantly reduce leaching. The improved soil amendment is particularly beneficial in farming applications in soils with low electrical conductivity, e.g. sandy soil types. Nutrient retention and controlled release of nutrients in the soil conceivably will provide a means to reduce fertilizer leaching, increase the concentration of plant available nutrients, and increase plant available moisture.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

Likewise, some of the components have been identified by the generic name of the product or by a well known trade name with the basic chemical formula (if available). The component name is used for ease and clarity of description. Although specific trade names and/or product names have been disclosed, the invention is not limited to those products, but should include any product that can be substituted for any of the recited component products.

What is claimed is:

1. A soil amendment comprising,
a pumpable liquid, wherein the pumpable liquid was formed by a mixture comprising
a cross-linked polymer having a particle size greater than 200 microns, and
a liquid fertilizer.

2. A soil amendment comprising,
a pumpable liquid, wherein the pumpable liquid was formed by a mixture comprising
a cross-linked polymer having a particle size greater than 200
microns,
a linear polymer, and
a liquid fertilizer.

3. A soil amendment comprising,
a pumpable liquid, wherein the pumpable liquid was formed by a mixture comprising
a cross-linked polymer having a particle size greater than 200 microns,
AMS, and
a liquid fertilizer.
